(19) United States
(12) Patent Application Publication
(10) Pub. No.: US 2007/0158610 A1
(43) Pub. Date: Jul. 12, 2007

(54) Carbon naoparticle-containing hydrophilic nanofluid

(76) Inventors: Haiping Hong, Rapid City, SD (US); Fernand D.S. Marquis, Rapid City, SD (US)

Correspondence Address: GORDON & REES LLP, 101 WEST BROADWAY, SUITE 1600, SAN DIEGO, CA, 92101, US

(21) Appl. No.: 11/332,682

(22) Filed: Jan. 12, 2006

(51) Int. Cl. C09K 5/00

(52) U.S. Cl. 252/71

(57) ABSTRACT

The present invention relates to a process for preparing a stable suspension of carbon nanoparticles in a hydrophilic thermal transfer fluid to enhance thermal conductive properties and other characteristics such as freezing point of an antifreeze coolant. The process involves the step of dispersing carbon nanoparticles directly into a mixture of a thermal transfer fluid and other additives in the present of surfactants with intermittent ultrasonication. The present invention also relates to the composition of a hydrophilic nanofluid, which comprises carbon nanoparticles, particularly carbon nanotubes, a hydrophilic thermal transfer fluid, and at least one surfactant. Addition of surfactants significantly increases the stability of nanoparticle dispersion.

### TECHNICAL FIELD

The present invention relates to a process for preparing a stable suspension of carbon nanoparticles in a hydrophilic thermal transfer fluid to enhance thermal conductive properties and other physical and chemical. The present invention also relates to the composition of a hydrophilic nanofluid, which comprises carbon nanoparticles, a hydrophilic thermal transfer fluid and at least one surfactant. Addition of surfactants significantly increases the stability of nanoparticle dispersion.

### BACKGROUND OF THE INVENTION

Conventional heat transfer fluids such as water, mineral oil, and ethylene glycol play an important role in many industries including power generation, chemical production, air conditioning, transportation, and microelectronics. However, their inherently low thermal conductivities have hampered the development of energy-efficient heat transfer fluids that are required in a plethora of heat transfer applications. It has been demonstrated recently that the heat transfer properties of these conventional fluids can be significantly enhanced by dispersing nanometer-sized solid particle and fibers (i.e. nanoparticles) in fluids (Eastman, et al., Appl. Phys. Lett. 2001, 78(6), 718; Choi, et al., Appl. Phys. Lett. 2001, 79(14), 2252). This new type of heat transfer suspensions is known as nanofluids. Carbon nanotube-containing nanofluids provide several advantages over the conventional fluids, including thermal conductivities far above those of traditional solid/liquid suspensions, a nonlinear relationship between thermal conductivity and concentration, strongly temperature-dependent thermal conductivity, and a significant increase in critical heat flux. Each of these features is highly desirable for thermal systems and together make nanofluids strong candidates for the next generation of heat transfer fluids.

The observed substantial increases in the thermal conductivities of nanofluids can have broad industrial applications and can also potentially generate numerous economical and environmental benefits. Enhancement in the heat transfer ability could translate into high energy efficiency, better performance, and low operating costs. The need for maintenance and repair can also be minimized by developing a nanofluid with a better wear and load-carrying capacity. Consequently, classical heat dissipating systems widely used today can become smaller and lighter, thus resulting in better fuel efficiency, less emission, and a cleaner environment.

Nanoparticles of various materials have been used to make heat transfer nanofluids, including copper, aluminum, copper oxide, alumina, titania, and carbon nanotubes (Keblinski, et al, Material today, 2005, 36). Of these nanoparticles, carbon nanotubes show greatest promise due to their excellent chemical stability and extraordinary thermal conductivity. Carbon nanotubes are macromolecules of the shape of a long thin cylinder and thus with a high aspect ratio. There are two main types of carbon nanotubes: single-walled nanotubes (“SWNT”) and multi-walled nanotubes (“MWNT”). The structure of a single-walled carbon nanotube can be described as a single graphene sheet rolled into a seamless cylinder whose ends either open or capped by either half fullerenes or more complex structures including pentagons. Multi-walled carbon nanotubes comprise an array of such nanotubes that are concentrically nested like rings of a tree trunk with a typical distance of approximately 0.34 nm between layers.

Carbon nanotubes are the most thermal conductive material known today. Basic research over the past decade has shown that carbon nanotubes could have a thermal conductivity an order of magnitude higher than copper, 3,000 W/m·K for multi-walled carbon nanotubes and 6,000 W/m·K for single-walled carbon nanotubes. Therefore, the thermal conductivities of nanofluids containing such solid particles would be expected to be significantly enhanced when compared with conventional fluids along. Experimental results have demonstrated that carbon nanotubes yield by far the highest thermal conductivity enhancement ever achieved in a fluid: a 150% increase in conductivity of oil at about 1% by volume of multi-walled carbon nanotubes (Choi, et al., App. Phys. Lett., 2001, 79(14), 2252).

Several additional studies of carbon nanotube suspensions in various heat transfer fluids have since been reported. However, only moderate enhancements in thermal conductivity have been observed. Xie et al. measured a carbon nanotube suspension in an aqueous solution of organic liquids and found only 10-20% increases in thermal conductivity at 1% by volume of carbon nanotubes (Xie, et al., J. Appl. Phys., 2003, 94(8):4967). Similarly, Wen and Ding found an about 25% enhancement in the conductivity at about 0.8% by volume of carbon nanotubes in water (Wen and Ding, J. Thermophys. Heat Trans., 2004, 18:481).

Despite those extraordinary promising thermal properties exhibited by carbon nanotube suspensions, it remains to be a serious technical challenge to effectively and efficiently disperse carbon nanotubes into aqueous or organic mediums to produce a nanoparticle suspension with a sustainable stability and consistent thermal properties. Due to hydrophobic natures of graphitic structure, carbon nanotubes are not soluble in any known solvent. They also have a very high tendency to form aggregates and extended structures of linked nanoparticles, thus leading to phase separation, poor dispersion within a matrix, and poor adhesion to the host. However, stability of the nanoparticle suspension is especially essential for practical industrial applications. Otherwise, the thermal properties of a nanofluid, such as thermal conductivity, will constantly changed as the solid nanoparticles gradually separate from the fluid. Unfortunately, these early studies on carbon nanotubes-containing nanofluids have primarily focused on the enhancement of thermal conductivity and very little experimental data is available regarding the stability of those nanoparticle suspensions.

Accordingly, there is a great need for development of an effective formulation which can be used to efficiently disperse different forms of carbon nanotubes into a desired heat transfer fluid and produce a nanofluid with a sustainable stability and consistent thermal properties. Hence, the present invention relates to a process for producing a carbon nanoparticle—containing nanofluid with significantly enhanced stability and thermal conductive properties. The present invention also relates to the composition of such nanofluid, which comprises carbon nanoparticles, a hydrophilic thermal transfer fluid, at least one surfactant, and other chemical additives.

### SUMMARY OF THE INVENTION

The objective of the present invention is to enhance thermal conductive properties of conventional thermal transfer fluids using solid carbon nanoparticles such as carbon nanotubes. Another objective of the present invention is to provide a method to stabilize such nanoparticle dispersion.

In accordance with the present invention, a process for preparing a stable suspension of carbon nanoparticles in a thermal transfer fluid is disclosed. The nanofluid of the present invention is produced by dispersing dry carbon nanoparticles directly into a mixture of a thermal transfer fluid and other additives in the present of surfactants with help of a physical agitation such as ultrasonication. If ultrasonication is used, it is preferably conducted in an intermittent mode so to avoid causing structural damage and alternation to nanoparticles, especially for carbon nanotubes.

The present invention also relates to the composition of a hydrophilic nanofluid, which is dispersion of carbon nanoparticles in conventional thermal transfer fluids, such as water and antifreeze coolants. In addition, a nanofluid also contains at least one surfactant to stabilize the nanoparticle dispersion. Other classical chemical additives can also be added to provide other desired chemical and physical characteristics, such as corrosion protection and scale prevention. Addition of carbon particles into the conventional thermal transfer fluids significantly increases their thermal conductivities and lowers their freezing points as well.

### DETAILED DESCRIPTION OF THE INVENTION

The present invention relates to a process for preparing a stable suspension of carbon nanoparticles in a hydrophilic thermal transfer fluid to enhance thermal conductive properties and other characteristics, such as lowering the freezing point of an antifreeze coolant. The process involves the step of dispersing carbon nanoparticles directly into a mixture of a thermal transfer fluid and other additives in the present of at least one surfactant with intermittent ultrasonication. The present invention also relates to the composition of a hydrophilic nanofluid, which comprises carbon nanoparticles, particularly carbon nanotubes, a hydrophilic thermal transfer fluid and at least one surfactant. Addition of surfactants significantly increases the stability of nanoparticle dispersion.

As used in this disclosure, the singular forms “a”, “an”, and “the” may refer to plural articles unless specifically stated otherwise. To facilitate understanding of the invention set forth in the disclosure that follows, a number of terms are defined below.

### Definitions

The term “carbon nanotube” refers to a class of macromolecules which have a shape of a long thin cylinder.

The term “aspect ratio” refers to a ratio of the length over the diameter of a particle.

The term “SWNT” refers to single-walled carbon nanotube.

The term “MWNT” refers to multi-walled carbon nanotube.

The term “D-SWNT” refers to a double-walled carbon nanotube.

The term “F-SWNT” refers to a fluorinated SWNT.

The term “carbon nanoparticle” refers to a nanoparticle which contain primarily carbon element, including diamond, graphite, fullerenes, and carbon nanotubes.

The term “surfactant” refers to a molecule having surface activity, including wetting agents, dispersants, emulsifiers, detergents, and foaming agents, etc.

### Carbon Nanoparticles:

Carbon nanoparticles have a high heat transfer coefficient and high thermal conductivity which often exceeds that of the best metallic material. Many forms of carbon nanoparticles can be used in the present invention, including carbon nanotubes, diamond, fullerenes, graphite, and combinations thereof.

Carbon nanotubes (“CNT”) are macromolecules in the shape of a long thin cylinder often with a diameter in few nanometers. The basic structural element in a carbon nanotube is a hexagon which is the same as that found in graphite. Based on the orientation of the tube axis with respect to the hexagonal lattice, a carbon nanotube can have three different configurations: armchair, zigzag, and chiral (also known as spiral). In armchair configuration, the tube axis is perpendicular to two of six carbon-carbon bonds of the hexagonal lattice. In zigzag configuration, the tube axis is parallel to two of six carbon-carbon bonds of the hexagonal lattice. Both these two configurations are achiral. In chiral configuration, the tube axis forms an angle other than 90 or 180 degrees with any of six carbon-carbon bonds of the hexagonal lattice. Nanotubes of these configurations often exhibit different physical and chemical properties. For example, an armchair nanotube is always metallic whereas a zigzag nanotube can be metallic or semiconductive depending on the diameter of the nanotube. All three different nanotubes are expected to be very good thermal conductors along the tube axis, exhibiting a property known as “ballistic conduction,” but good insulators laterally to the tube axis.

In addition to the common hexagonal structure, the cylinder of a carbon nanotube molecule can also contain other size rings, such as pentagon and heptagon. Replacement of some regular hexagons with pentagons and/or heptagons can cause cylinders to bend, twist, or change diameter, and thus lead to some interesting structures such as “Y-”, “T-”, and “X-junctions”. Those various structural variations and configurations can be found in both SWNT and MWNT. However, the present invention is not limited by any particular configuration and structural variation. The carbon nanotube used in the present invention can be in the configuration of armchair, zigzag, chiral, or combinations thereof. The nanotube can also contain structural elements other than hexagon, such as pentagon, heptagon, octagon, or combinations thereof.

Another structural variation for MWNT molecules is the arrangement of the multiple tubes. A perfect MWNT is like a stack of graphene sheets rolled up into concentric cylinders with each wall parallel to the central axis. However, the tubes can also be arranged so that an angle between the graphite basal planes and the tube axis is formed. Such MWNT is known as a stacked cone, Chevron, bamboo, ice cream cone, or piled cone structures. A stacked cone MWNT can reach a diameter of about 100 nm. In spite of these structural variations, all MWNTs are suitable for the present invention as long as they have an excellent thermal conductivity.

Carbon nanotubes used in the present invention can also encapsulate other elements and/or molecules within their enclosed tubular structures. Such elements include Si, Ti, V, Cr, Mn, Fe, Co, Ni, Cu, Y, Zr, Mo, Ta, Au, Th, La, Ce, Pr, Nb, Gd, Tb, Dy, Ho, Er, Tm, Yb, Lu, Mo, Pd, Sn, and W. Such molecules include alloys of these elements such as alloys of Cobalt with S, Br, Pb, Pt, Y, Cu, B, and Mg, and compounds such as the carbides (i.e. TiC, MoC, etc.). The present of these elements, alloys and compounds within the core structure of fullerenes and nanotubes can enhance the thermal conductivity of these nanoparticles which then translates to a higher thermal conductive nanofluid when these nanoparticles are suspend in a heat transfer fluid.

Carbon nanoparticles used in the present invention can also be chemically modified and functionalized, such as covalently attached hydrophilic groups for hydrophilic fluids or lipophilic chains for hydrophobic oils. Covalent functionalization of carbon nanoparticles, especially carbon nanotubes and fullerenes, has commonly been accomplished by three different approaches, namely, thermally activated chemistry, electrochemical modification, and photochemical functionalization. The most common methods of thermally activated chemical functionalization are addition reactions on the sidewalls. For example, the extensive treatment of a nanotube with concentrated nitric and sulfuric acids leads to the oxidative opening of the tube caps as well as the formation of holes in the sidewalls and thus produces a nanotube decorated with carboxyl groups, which can be further modified through the creation of amide and ester bonds to generate a vast variety of functional groups. The nanotube molecule can also be modified through addition reactions with various chemical reagents such halogens and ozone. Unlike thermally controlled modification, electrochemical modification of nanotubes can be carried out in more selective and controlled manner. Interestingly, a SWNT can be selectively modified or functionalized either on the cylinder sidewall or the optional end caps. These two distinct structural moieties often display different chemical and physical characteristics.

The term “carbon nanotube” used in the present invention covers all structural variations and modification of SWNT and MWNT discussed hereinabove, including configurations, structural defeats and variations, tube arrangements, chemical modification and functionalization, and encapsulation.

Carbon nanotubes are commercially available from a variety of sources. Single-walled carbon nanotubes can be obtained from Carbolex (Broomall, PA.), MER Corporation (Tucson, Ariz.), and Carbon Nanotechnologies Incorporation (“CNI”, Houston, Tex.). Multi-walled carbon nanotubes can be obtained from MER Corporation (Tucson, Ariz.) and Helix material solution (Richardson, Tex.). However, the present invention is not limited by the source of carbon nanotubes. In addition, many publications are available with sufficient information to allow one to manufacture nanotubes with desired structures and properties. The most common techniques are arc discharge, laser ablation, chemical vapor deposition, and flame synthesis. In general, the chemical vapor deposition has shown the most promise in being able to produce larger quantities of nanotubes at lower cost. This is usually done by reacting a carbon-containing gas, such as acetylene, ethylene, ethanol, etc., with a metal catalyst particle, such as cobalt, nickel, or ion, at temperatures above 600° C.

The selection of a particular carbon nanoparticle depends on a number of factors. The most important one is that the nanoparticle has to be compatible with an already existing base fluid discussed thereafter. Other factors include heat transfer properties, cost effectiveness, dispersion and settling characteristics. In one embodiment of the present invention, the carbon nanoparticles selected contain predominantly single-walled nanotubes. In one aspect, the carbon nanotube has a carbon content of no less than 60%, preferably no less than 80%, more preferably no less than 90%, still more preferably no less than 95%, still more preferably no less than 98%, and most preferably no less than 99%. In another aspect, the carbon nanotube has a diameter of from about 0.2 nm to about 100 nm, more preferably from about 0.4 nm to about 80 nm, still more preferably from about 0.5 nm to about 60 nm, and most preferably from about 0.5 nm to 50 nm. In yet another aspect, the carbon nanotube is no greater than about 200 micrometers in length, preferably no greater than 100 micrometers, more preferably no greater than about 50 micrometers, and most preferably no greater than 20 micrometers. In yet another aspect, the carbon nanotube has an aspect ratio of no greater than 1,000,000, preferably no greater than 100,000, more preferably no greater than 10,000, still more preferably no greater than 1,000, still more preferably no greater than 500, still more preferably no greater than 200, and most preferably no greater than 100. In yet another aspect, the carbon nanotube has a thermal conductivity of no less than 10 W/m·K, preferably no less than 100 W/m·K, more preferably no less than 500 W/m·K, most preferably no less than 1000 W/m·K.

In another embodiment, the carbon particles used in the present invention are multi-walled carbon nanotubes. In one aspect, the carbon nanotube has a carbon content of no less than 60%, preferably no less than 80%, more preferably no less than 90%, still more preferably no less than 95%, still more preferably no less than 98%, and most preferably no less than 99%. In another aspect, the carbon nanotube has a diameter of from about 0.2 nm to about 100 nm, more preferably from about 0.4 nm to about 80 nm, still more preferably from about 0.5 nm to about 60 nm, and most preferably from about 0.5 nm to 50 nm. In yet another aspect, the carbon nanotube is no greater than about 200 micrometers in length, preferably no greater than 100 micrometers, more preferably no greater than about 50 micrometers, and most preferably no greater than 20 micrometers. In yet another aspect, the carbon nanotube has an aspect ratio of no greater than 1,000,000, preferably no greater than 100,000, more preferably no greater than 10,000, still more preferably no greater than 1,000, still more preferably no greater than 500, still more preferably no greater than 200, and most preferably no greater than 100. In yet another aspect, the carbon nanotube has a thermal conductivity of no less than 10 W/m·K, preferably no less than 100 W/m·K, more preferably no less than 500 W/m·K, most preferably no less than 1000 W/m·K.

In yet another embodiment, the carbon particles are diamond nanoparticles, graphite nanoparticles, or fullerenes. In yet another embodiment, the carbon particles are a combination of two or more selected from diamond nanoparticles, graphite nanoparticles, fullerenes, and carbon nanotubes. A combination can be a mixture of two or more nanoparticles of the same type or of different types. For examples, a combination of two nanoparticles can be a mixture of SWNT and MWNT, a mixture of two SWNTs with different properties and/or manufactory methods, a mixture of two MWNT with different properties and/or manufactory methods, a mixture of carbon nanotubes with graphite nanoparticles, a mixture of carbon nanotubes with diamond particles, and a mixture of carbon nanotubes with fullerenes.

### Thermal Transfer Fluid:

The major component of the hydrophilic nanofluid of the present invention is a thermal transfer fluid, which is a hydrophilic liquid or an aqueous solution. Preferred hydrophilic liquids are those that are miscible with water, including water, aliphatic alcohols, alkylene glycols, di(alkylene) glycols, monoalkyl ethers of alkylene glycols or di(alkylene) glycols, and various mixtures thereof. Suitable aliphatic alcohols contain no greater than 6 carbons and no greater than 4 hydroxyls, such as methanol, ethanol, isopropanol, and glycerol. Suitable alkylene glycols contain no greater than 5 carbons, such as ethylene glycol, propylene glycol, and 1,2-butylene glycol. Preferably, the thermal transfer fluid of the present invention contains ethylene glycol, propylene glycol, and mixtures thereof. Ethylene glycol and propylene glycol are excellent antifreeze agents and markedly reduce the freezing point of water. Suitable di(alkylene) glycols contain no greater than 10 carbons, such as diethylene glycol, triethylene glycol, tetraethylene glycol, and dipropylene glycol. Commercial antifreeze coolants often contain more than one glycol compounds. For example, Prestone antifreeze coolant contains 95 to 100% of ethylene glycol and no greater than 5% of diethylene glycol. The mixture as used herein refers to a combination of two or more hydrophilic liquids.

The term “alkylene glycol” used in the present invention refers to a molecule having glycol functional moiety in its structure, including alkylene glycol, alkylene glycols, di(alkylene)glycols, tri(alkylene)glycols, tetra(alkylene)glycols, and their various derivatives, such as ethers and carboxylic esters. Examples of ether derivatives are (monoalkyl ethers of alkylene glycols or di(alkylene) glycols).

### Other Chemical Additives:

The nanofluids of the present invention may also contain one or more other chemicals to provide other desired chemical and physical properties and characteristics. Such chemical additives include buffering agents, corrosion inhibitors, defoamers, scale inhibitors, and dyes.

The buffering agents for use in the present invention can be selected from any known or commonly used buffering agents. It will be appreciated by those skilled in the art that selected buffering agents can exhibit both anti-corrosion and buffering properties. In certain formulations, for example, benzoates, borates, and phosphates can provide both buffering and anti-corrosion advantages. In addition a base can be used to adjust the pH value of a nanofluid. Illustrative examples of bases for use with this invention include commonly known and used bases, for example, inorganic bases such as KOH, NaOH, NaHCO₃, K₂CO₃, and Na₂CO₃. Therefore, the buffering system and base can be adapted to provide a nanofluid composition with a pH level between 7.5 and about 11.

The corrosion inhibitors for use in the present invention can be either an organic additive or an inorganic additive. Suitable organic anti-corrosive additives include short aliphatic dicarboxylic acids such as maleic acid, succinic acid, and adipic acid; triazoles such as benzotriazole and tolytriazole; thiazoles suchs as mercaptobenzothiazole; thiadiazoles such as 2-mercapto-5-hydrocarbylthio-1,3,4-thiadiazoles,2-mercapto-5-hydrocarbyldithio-1,3,4-thiadiazoles, 2,5-bis(hydrocarbylthio)-1,3,4-thiadiazoles, and 2,5-(bis)hydrocarbyldithio)-1,3,4-thiadiazoles; sulfonates; and imidazolines. Suitable inorganic additives include borates, phosphates, silicates, nitrates, nitrites, and molybdates.

The basic composition of the nanofluids of the present invention can be tailored for selective applications. For example, nitrates and silicates are known to provide aluminum protection. Borates and nitrites can be added for ferrous metal protection, and benzotriazole and tolytriazole can be added for copper and brass protection.

Suitable defoamers include components such as silicon defoamers, alcohols such as polyethoxylated glycol, polypropoxylated glycol or acetylenic glycols.

Suitable scale inhibitors include components such as phosphate esters, phosphino carboxylate, polyacrylates, polymethacylate, styrene-maleic anhydride, sulfonates, maleic anhydride co-polymer, and acrylate-sulfonate co-polymer.

### Surfactant:

A variety of surfactants can be used in the present invention as a dispersant to facilitate uniform dispersion of nanoparticles and to enhance stabilization of such dispersion as well. Typically, the surfactants used in the present invention contain an lipophilic hydrocarbon group and a polar functional hydrophilic group. The polar functional group can be of the class of carboxylate, ester, amine, amide, imide, hydroxyl, ether, nitrile, phosphate, sulfate, or sulfonate. The surfactant can be anionic, cationic, nonionic, zwitterionic, amphoteric and ampholytic.

In one embodiment, the surfactant is anionic, including sulfonates such as alkyl sulfonates, alkylbenzene sulfonates, alpha olefin sulfonates, paraffin sulfonates, and alkyl ester sulfonates; sulfates such as alkyl sulfates, alkyl alkoxy sulfates, and alkyl alkoxylated sulfates; phosphates such as monoalkyl phosphates and dialkyl phosphates; phosphonates; carboxylates such as fatty acids, alkyl alkoxy carboxylates, sarcosinates, isethionates, and taurates. Specific examples of carboxylates are sodium cocoyl isethionate, sodium methyl oleoyl taurate, sodium laureth carboxylate, sodium trideceth carboxylate, sodium lauryl sarcosinate, lauroyl sarcosine, and cocoyl sarcosinate. Specific examples of sulfates include sodium dodecyl sulfate, sodium lauryl sulfate, sodium laureth sulfate, sodium trideceth sulfate, sodium tridecyl sulfate, sodium cocyl sulfate, and lauric monoglyceride sodium sulfate.

Suitable sulfonate surfactants include alkyl sulfonates, aryl sulfonates, monoalkyl and dialkyl sulfosuccinates, and monoalkyl and dialkyl sulfosuccinamates. Each alkyl group independently contains about two to twenty carbons and can also be ethoxylated with up to about 8 units, preferably up to about 6 units, on average, e.g., 2, 3, or 4 units, of ethylene oxide, per each alkyl group. Illustrative examples of alky and aryl sulfonates are sodium tridecyl benzene sulfonate and sodium dodecylbenzene sulfonate (“SDBS”).

Illustrative examples of sulfosuccinates include, but not limited to, dimethicone copolyol sulfosuccinate, diamyl sulfosuccinate, dicapryl sulfosuccinate, dicyclohexyl sulfosuccinate, diheptyl sulfosuccinate, dihexyl sulfosuccinate, diisobutyl sulfosuccinate, dioctyl sulfosuccinate, C12-15 pareth sulfosuccinate, cetearyl sulfosuccinate, cocopolyglucose sulfosuccinate, cocoyl butyl gluceth-10 sulfosuccinate, deceth-5 sulfosuccinate, deceth-6 sulfosuccinate, dihydroxyethyl sulfosuccinylundecylenate, hydrogenated cottonseed glyceride sulfosuccinate, isodecyl sulfosuccinate, isostearyl sulfosuccinate, laneth-5 sulfosuccinate, laureth sulfosuccinate, laureth-12 sulfosuccinate, laureth-6 sulfosuccinate, laureth-9 sulfosuccinate, lauryl sulfosuccinate, nonoxynol-10 sulfosuccinate, oleth-3 sulfosuccinate, oleyl sulfosuccinate, PEG-10 laurylcitrate sulfosuccinate, sitosereth-14 sulfosuccinate, stearyl sulfosuccinate, tallow, tridecyl sulfosuccinate, ditridecyl sulfosuccinate, bisglycol ricinosulfosuccinate, di(1,3-di-methylbutyl)sulfosuccinate, and silicone copolyol sulfosuccinates. The structures of silicone copolyol sulfosuccinates are set forth in U.S. Pat. Nos. 4,717,498 and 4,849,127, herein incorporated by reference.

Illustrative examples of sulfosuccinamates include, but not limited to,lauramido-MEA sulfosuccinate, oleamido PEG-2 sulfosuccinate,cocamido MIPA-sulfosuccinate,cocamido PEG-3 sulfosuccinate, isostearamido MEA-sulfosuccinate, isostearamido MIPA-sulfosuccinate, lauramidoMEA-sulfosuccinate, lauramido PEG-2 sulfosuccinate, lauramido PEG-5 sulfosuccinate, myristamido MEA-sulfosuccinate, oleamido MEA-sulfosuccinate, oleamido PIPA-sulfosuccinate, oleamido PEG-2sulfosuccinate, palmitamido PEG-2 sulfosuccinate, palmitoleamido PEG-2 sulfosuccinate, PEG-4 cocamido MIPA-sulfosuccinate, ricinoleamido MEA-sulfosuccinate, stearamido MEA-sulfosuccinate, stearyl sulfosuccinamate, tallamido MEA-sulfosuccinate, tallow sulfosuccinamate, tallowamido MEA-sulfosuccinate, undecylenamido MEA-sulfosuccinate, undecylenamido PEG-2 sulfosuccinate,wheat germamido MEA-sulfosuccinate, and wheat germamido PEG-2 sulfosuccinate.

Some examples of commercial sulfonates are AEROSOL® OT-S, AEROSOL® OT-MSO, AEROSOL® TR70% (Cytec inc, West Paterson, N.J.), NaSul CA-HT3 (King industries, Norwalk, Conn.), and C500 (Crompton Co, West Hill, Ontario, Canada). AEROSOL® OT-S is sodium dioctyl sulfosuccinate in petroleum distillate. AEROSOL® OT-MSO also contains sodium dioctyl sulfosuccinate. AEROSOL® TR70% is sodium bistridecyl sulfosuccinate in mixture of ethanol and water. NaSul CA-HT3 is calcium dinonylnaphthalene sulfonate/carboxylate complex. C500 is an oil soluble calcium sulfonate.

For an anionic surfactant, the counter ion is typically sodium but may alternatively be potassium, lithium, calcium, magnesium, ammonium, amines (primary, secondary, tertiary or quandary) or other organic bases. Exemplary amines include isopropylamine, ethanolamine, diethanolamine, and triethanolamine. Mixtures of the above cations may also be used.

In another embodiment, the surfactant is cationic, including primarily organic amines, primary, secondary, tertiary or quaternary. For a cationic surfactant, the counter ion can be chloride, bromide, methosulfate, ethosulfate, lactate, saccharinate, acetate and phosphate. Examples of cationic amines include polyethoxylated oleyl/stearyl amine, ethoxylated tallow amine, cocoalkylamine, oleylamine, and tallow alkyl amine.

Examples of quaternary amines with a single long alkyl group are cetyl trimethyl ammonium bromide (“CETAB”),dodecyltrimethylammonium bromide,myristyl trimethyl ammonium bromide, stearyl dimethyl benzyl ammonium chloride,oleyl dimethyl benzyl ammonium chloride, lauryl trimethyl ammonium methosulfate (also known as cocotrimonium methosulfate), cetyl-dimethyl hydroxyethyl ammonium dihydrogen phosphate, bassuamidopropylkonium chloride, cocotrimonium chloride, distearyldimonium chloride, wheat germ-amidopropalkonium chloride, stearyl octyidimonium methosulfate, isostearaminopropal-konium chloride, dihydroxypropyl PEG-5 linoleammonium chloride, PEG-2 stearmonium chloride, behentrimonium chloride, dicetyl dimonium chloride, tallow trimonium chloride and behenamidopropyl ethyl dimonium ethosulfate.

Examples of quaternary amines with two long alkyl groups are distearyldimonium chloride, dicetyl dimonium chloride, stearyl octyldimonium methosulfate, dihydrogenated palmoylethyl hydroxyethylmonium methosulfate, dipalmitoylethyl hydroxyethylmonium methosulfate, dioleoylethyl hydroxyethylmonium methosulfate, and hydroxypropyl bisstearyldimonium chloride.

Quaternary ammonium compounds of imidazoline derivatives include, for example, isostearyl benzylimidonium chloride, cocoyl benzyl hydroxyethyl imidazolinium chloride, cocoyl hydroxyethylimidazolinium PG-chloride phosphate, and stearyl hydroxyethylimidonium chloride. Other heterocyclic quaternary ammonium compounds, such as dodecylpyridinium chloride, can also be used.

In yet another embodiment, the surfactant is nonionic, including polyalkylene oxide carboxylic acid esters, fatty acid esters, fatty alcohols, ethoxylated fatty alcohols, poloxamers, alkanolamides, alkoxylated alkanolamides, polyethylene glycol monoalkyl ether, and alkyl polysaccharides. Polyalkylene oxide carboxylic acid esters have one or two carboxylic ester moieties each with about 8 to 20 carbons and a polyalkylene oxide moiety containing about 5 to 200 alkylene oxide units. A ethoxylated fatty alcohol contains an ethylene oxide moiety containing about 5 to 150 ethylene oxide units and a fatty alcohol moiety with about 6 to about 30 carbons. The fatty alcohol moiety can be cyclic, straight, or branched, and saturated or unsaturated. Some examples of ethoxylated fatty alcohols include ethylene glycol ethers of oleth alcohol, steareth alcohol, lauryl alcohol and isocetyl alcohol. Poloxamers are ethylene oxide and propylene oxide block copolymers, having from about 15 to about 100 moles of ethylene oxide. Alkyl polysaccharide (“APS”) surfactants (e.g. alkyl polyglycosides) contain a hydrophobic group with about 6 to about 30 carbons and a polysaccharide (e.g., polyglycoside) as the hydrophilic group. An example of commercial nonionic surfactant is FOA-5 (Octel Starreon LLC., Littleton, Colo.).

Specific examples of suitable nonionic surfactants include alkanolamides such as cocamide diethanolamide (“DEA”), cocamide monoethanolamide (“MEA”), cocamide monoisopropanolamide (“MIPA”), PEG-5 cocamide MEA, lauramide DEA, and lauramide MEA; alkyl amine oxides such as lauramine oxide, cocamine oxide, cocamidopropylamine oxide, and lauramidopropylamine oxide; sorbitan laurate, sorbitan distearate,fatty acids or fatty acid esters such as lauric acid, isostearic acid, and PEG-150 distearate; fatty alcohols or ethoxylated fatty alcohols such as lauryl alcohol, alkylpolyglucosides such as decyl glucoside, lauryl glucoside, and coco glucoside.

In yet another embodiment, the surfactant is zwitterionic, which has both a formal positive and negative charge on the same molecule. The positive charge group can be quaternary ammonium, phosphonium, or sulfonium, whereas the negative charge group can be carboxylate, sulfonate, sulfate, phosphate or phosphonate. Similar to other classes of surfactants, the hydrophobic moiety may contain one or more long, straight, cyclic, or branched, aliphatic chains of about 8 to 18 carbon atoms. Specific examples of zwitterionic surfactants include alkyl betaines such as cocodimethyl carboxymethyl betaine, lauryl dimethyl carboxymethyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl)carboxymethyl betaine, oleyl dimethyl gamma-carboxypropyl betaine, and lauryl bis-(2-hydroxypropyl)alphacarboxy-ethyl betaine, amidopropyl betaines; and alkyl sultaines such as cocodimethyl sulfopropyl betaine, stearyidimethyl sulfopropyl betaine, lauryl dimethyl sulfoethyl betaine, lauryl bis-(2-hydroxyethyl)sulfopropyl betaine, and alkylamidopropylhydroxy sultaines.

In yet another embodiment, the surfactant is amphoteric. Suitable examples of suitable amphoteric surfactants include ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates. Specific examples are cocoamphoacetate, cocoamphopropionate, cocoamphodiacetate, lauroamphoacetate, lauroamphodiacetate, lauroamphodipropionate, lauroamphodiacetate, cocoamphopropyl sulfonate, caproamphodiacetate, caproamphoacetate, caproamphodipropionate, and stearoamphoacetate.

In yet another embodiment, the surfactant is a polymer such as N-substituted polyisobutenyl succinimides and succinates, alkyl methacrylate vinyl pyrrolidinone copolymers, alkyl methacrylate-dialkylaminoethyl methacrylate copolymers, alkylmethacrylate polyethylene glycol methacrylate copolymers, and polystearamides.

In yet another embodiment, the surfactant is an oil-based dispersant, which includes alkylsuccinimide, succinate esters, high molecular weight amines, and Mannich base and phosphoric acid derivatives. Some specific examples are polyisobutenyl succinimide-polyethylenepolyamine, polyisobutenyl succinic ester, polyisobutenyl hydroxybenzyl-polyethylenepolyamine, and bis-hydroxypropyl phosphorate.

In yet another embodiment, the surfactant used in the present invention is a combination of two or more selected from the group consisting of anionic, cationic, nonionic, zwitterionic, amphoteric, and ampholytic surfactants. Suitable examples of a combination of two or more surfactants of the same type include, but not limited to, a mixture of two anionic surfactants, a mixture of three anionic surfactants, a mixture of four anionic surfactants, a mixture of two cationic surfactants, a mixture of three cationic surfactants, a mixture of four cationic surfactants, a mixture of two nonionic surfactants, a mixture of three nonionic surfactants, a mixture of four nonionic surfactants, a mixture of two zwitterionic surfactants, a mixture of three zwitterionic surfactants, a mixture of four zwitterionic surfactants, a mixture of two amphoteric surfactants, a mixture of three amphoteric surfactants, a mixture of four amphoteric surfactants, a mixture of two ampholytic surfactants, a mixture of three ampholytic surfactants, and a mixture of four ampholytic surfactants.

Suitable examples of a combination of two surfactants of the different types include, but not limited to, a mixture of one anionic and one cationic surfactant, a mixture of one anionic and one nonionic surfactant, a mixture of one anionic and one zwitterionic surfactant, a mixture of one anionic and one amphoteric surfactant, a mixture of one anionic and one ampholytic surfactant, a mixture of one cationic and one nonionic surfactant, a mixture of one cationic and one zwitterionic surfactant, a mixture of one cationic and one amphoteric surfactant, a mixture of one cationic and one ampholytic surfactant, a mixture of one nonionic and one zwitterionic surfactant, a mixture of one nonionic and one amphoteric surfactant, a mixture of one nonionic and one ampholytic surfactant, a mixture of one zwitterionic and one amphoteric surfactant, a mixture of one zwitterionic and one ampholytic surfactant, and a mixture of one amphoteric and one ampholytic surfactant. A combination of two or more surfactants of the same type, e.g., a mixture of two anionic surfactants, is also included in the present invention.

### Physical Agitation:

The nanofluid of the present invention is prepared by dispersing a mixture of the appropriate surfactant, lubricant, carbon nanomaterials, and other chemical additives using a physical method to form a stable suspension of carbon nanoparticles in a thermal transfer fluid. A variety of physical mixing methods can be used in the present invention, including high shear mixing, such as with a high speed mixer, homogenizers, microfluidizers, high impact mixing, and ultrasonication methods. Among these methods, unltrasonication is the least destructive to the structures of carbon nanoparticles. Ultrasonication can be done either in the bath-type ultrasonicator, or by the tip-type ultrasonicator. Typically, tip-type ultrasonication is for applications which require higher energy output. Ultrasonication at a medium-high instrumental intensity for up to 60 minutes, and usually in a range of from 10 to 30 minutes is desired to achieve better homogeneity. Additional, the mixture is sonicated intermittently to avoid overheating. It is well known that overheating can break the carbon nanotubes to lose conjugated bonds and hence lose their beneficial physical properties. The terms “ultrasonication” and “sonication” are used interchangeably throughout the instant disclosure.

The raw material mixture may be pulverized by any suitable known dry or wet grinding method. One grinding method includes pulverizing the raw material mixture in the fluid mixture of the present invention to obtain a concentrate, and the pulverized product may then be dispersed further in a liquid medium with the aid of the dispersants described above. However, pulverization or milling often reduces the carbon nanotube average aspect ratio.

It will be appreciated that the individual components can be separately blended into the base fluid or can be blended therein in various subcombinations, if desired. Ordinarily, the particular sequence of such blending steps is not critical. Moreover, such components can be blended in the form of separate solutions in a diluent. It is preferable, however, to blend the components used in the form of an additive concentrate as this simplifies the blending operations, reduces the likelihood of blending errors, and takes advantage of the compatibility and solubility characteristics afforded by the overall concentrate.

### Nanofluids:

The nanofluid of the present invention is a dispersion of carbon nanoparticles in a thermal transfer fluid in the present of surfactants. The surfactants are used to stabilize the nanoparticle dispersion. The hydrophilic thermal transfer fluid may contain one or more hydrophilic molecules. Preferably, the thermal transfer fluid contains water, aliphatic alcohols, alkylene glycols, or various mixtures thereof. More preferably, the thermal transfer fluid contains water, alkylene glycols, and various mixtures thereof. Most preferably, the thermal transfer fluid contains water, ethylene glycol, diethylene glycol, and mixtures thereof. In one aspect, the thermal transfer fluid is a two-component mixture which contains water and ethylene glycol in various proportions. Preferably, the thermal transfer fluid contains about 0.1 to 99.9% by volume of water more preferably 20 to 80%, yet more preferably 40 to 60%, and most preferably about 50%.

In another aspect, the thermal transfer fluid is a three-component mixture which contains water, ethylene glycol, and diethylene glycol in various proportions. The thermal transfer fluid may contain about 0.1 to 99.9% by volume of water, about 0.1 to 99.9% by volume of ethylene glycol, and about 0.1 to 99.9% by volume of diethylene glycol. The thermal transfer fluid preferably contains about 20 to 80% by volume of water or ethylene glycol, more preferably 40 to 60%, and most preferably about 50%. Typically, diethylene glycol constitutes a minor component of the thermal transfer fluid, preferably in no greater than about 20% of the total volume, more preferably no greater than about 10%, and most preferably no greater than about 5%. Nevertheless, the total amount of all the components in a thermal transfer fluid together should equal to 100%.

Typically, the hydrophilic nanofluid of the present invention contains three types of components: a thermal transfer fluid, carbon nanoparticles, and surfactants. In one aspect, the nanofluid contains from no less than about 80% by weight of a thermal transfer fluid, preferably no less than about 85%, more preferably no less than about 90%, and most preferably no less than about 95%.

In another aspect, the nanofluid contains no greater than about 10% by weight of carbon nanoparticles, preferably no greater than 5%, more preferably no greater than about 2.5%, most preferably no greater than about 1%. The carbon nanoparticles are selected from diamond nanoparticles, graphite nanoparticles, fullerenes, carbon nanotubes, and combinations thereof.

In yet another aspect, the nanofluid contains at least one surfactant as a dispersant agent to stabilize the nanoparticle suspension. The surfactant is selected from anionic, cationic, nonionic, zwitterionic, amphoteric, ampholytic surfactants, and combinations thereof. The nanofluid contains from about 0.1 to about 30% by weight of surfactants, preferably from about 1 to about 20%, more preferably from about 1 to 15%, and most preferably from about 1 to 10%.

Optionally, the nanofluid can also contain other additives to improve chemical and/or physical properties. Typically, the amount of these additives together is no greater than 10% by weight of the nanofluid. Nevertheless, the total amount of all the ingredients of the nanofluid together should equal to 100%.

The nanofluid of the present invention is prepared by dispersing carbon nanoparticles directly into a mixture of a thermal transfer fluid and other additives in the present of at least one surfactant with a physical agitation, such as ultrasonication. Preferably, the ultrasonication is operated in intermittent mode to avoid causing structural damage to carbon nanoparticles. The carbon nanoparticle-containing mixture is energized for a predetermined period of time with a break in between. Each energizing period is no more than about 30 min, preferably no more than about 15 min, more preferably no more than 10 min, and most preferably no more than 5 min. The break between ultrasonication pulses provides the opportunities for the energized carbon nanoparitcles to dissipate the energy. The break is preferably no less than about 1 min, more preferably no less than about 2 min, yet more preferably no less than about 5 min, and most preferably from about 5 to about 10 min. The order of addition of the individual components is not critical for the practice of the invention. However, it is desired to the nanofluid composition be thoroughly blended and that all the components be completely dissolved to provide optimum performance.

The hydrophilic nanofluid of carbon nanoparticles thus produced has enhanced thermal properties and physical and chemical characteristics. Addition of solid carbon nanoparticles, in particular, carbon nanotubes, enhances both thermal conductivity and lowers freezing point of the thermal conductivity fluid. Incorporation of about 0.05% by weight of carbon nanotubes, the thermal conductivity is increased from 0.45 to about 0.48-0.50, which is an about 6 to 11% increase. In addition, the freezing point of the thermal transfer fluid is also lowered significantly. Incorporation of about 0.05% by weight of carbon nanotubes, the freezing point is decreased from −35.6 to −40° C., which is about 12% enhancement.

### EXAMPLES

Carbon nanotubes from several commercial sources were used in the following examples and their information is summarized in Table 1. In addition, two standard solutions were used throughout all examples: the “PAC Solution”, which is a one-to-one mixture of Prestone antifreeze coolant (“PAC”) and water, and the “EG Solution” is a one-to-one mixture of ethylene glycol (“EG”) and water.

TABLE 1

| | | Commercial |
|---|---|---|
| Abbreviation | Product Information | Source |
| MWNT-HMSI | MWNT with a diameter | Helix Material |
| | of 10–20 nm and | Solution Inc |
| | a length of 0.5–40 micrometers | |
| MWNT-MER | MWNT with a diameter | Materials and |
| | of 140 ± 30 nm, a length | Electrochemical |
| | of 7 ± 2 micrometers, and a | Research |
| | purity of over 90%. | Corporation |
| MWNT-RAO | MWNT with diameter | RAO |
| | 20–25 nm, | |
| SWNT-MER | SWNT 0.7–1.2 nm in diameter, | MER |
| | 10–50 micron lengths. | |
| SWNT-CAR | Purified CAR SWNT | AP CAR |
| SWNT-CNI | ESD SWNT | CNI |
| D-SWNT-CNI | D-SWNT bundles | CNI |
| F-SWNT-CNI | Purified F-SWNT | CNI |
| SWNT-HIPCO | SWNT | Hipco |

### Example I

### Acid Treatment of Carbon Nanotubes

A suspension of carbon nanotubes (5% by weight) in sulfuric acid/nitrate acid (3:1) was heated at 110° C. under nitrogen for about 3 days. The suspension was then diluted with deionized water and filtered to remove the acids. After further washed with acetone and deionized water, the solid was dried in an oven at about 60 to 70° C. overnight.

### Example II

### Preparation of a SWNT-Containing Nanofluid

A SWNT nanofluid in EG Solution was prepared by dispersing dry carbon nanotubes into a mixture of the thermal transfer fluid (i.e., EG Solution) and a surfactant as a dispersant according to the composition and condition specified in Table 2. The dispersion was carried out by ultrasonication intermittently for 15 min using Digital Sonifier Model 102C by Branson Ultrasonics Corporation (Monroe Township, N.J.), to avoid causing structural damage to carbon nanotubes. Typically, the carbon nanoparticle-containing mixture is energized for 1-2 min with a break about 5-10 min in between.

TABLE 2

| Component | Description | Weight (%) |
|---|---|---|
| Carbon nanotube | F-SWNT-CNI, untreated | 0.05 |
| Surfactant | Nanolab dispersant | 5.00 |
| Heat transfer fluid | EG Solution | 94.85 |
| Ultrasonication Time | 15 min | |
| Dispersion Quality | Good | |
| Dispersion Stability | More than one week | |

### Example III

### Preparation of a SWNT-Containinz Nanofluid

A nanofluid with the composition specified in Table 3 was prepared as described in Example II.

TABLE 3

| Component | Description | Weight (%) |
|---|---|---|
| Carbon nanotube | F-SWNT-CNI, untreated | 0.10 |
| Surfactant | SDBS | 1.00 |
| Heat transfer fluid | EG Solution | 98.90 |
| Ultrasonication Time | 20 min | |
| Dispersion Quality | Good | |
| Dispersion Stability | More than one month | |

### Example IV

### Preparation of a SWNT-Containinz Nanofluid

A nanofluid with the composition specified in Table 4 was prepared as described in Example II.

TABLE 4

| Component | Description | Weight (%) |
|---|---|---|
| Carbon nanotube | F-SWNT-CNI, untreated | 0.2 |
| Surfactant | SDBS | 1.0 |
| Heat transfer fluid | PAC Solution | 98.8 |
| Other additives | TGA | 0.01–0.03% |
| Ultrasonication Time | 25 min | |
| Dispersion Quality | Good | |
| Dispersion Stability | More than one month | |

### Example V

### Preparation of a SWNT-Containing Nanofluid

A nanofluid with the composition specified in Table 5 was prepared as described in Example II.

TABLE 5

| Component | Description | Weight (%) |
|---|---|---|
| Carbon nanotube | F-SWNT-CNI, untreated | 0.05 |
| Surfactant | SDBS | 1.50 |
| Heat transfer fluid | PAC Solution | 98.45 |
| Ultrasonication Time | 15 min | |
| Dispersion Quality | Good | |
| Dispersion Stability | More than two weeks | |

### Example VI

### Preparation of a SWNT-Containing Nanofluid

A nanofluid with the composition specified in Table 6 was prepared as described in Example II.

TABLE 6

| Component | Description | Weight (%) |
|---|---|---|
| Carbon nanotube | D-SWNT-CNI, acid treated | 0.05 |
| Surfactant | SDBS | 1.00 |
| Heat transfer fluid | PAC Solution | 98.95 |
| Ultrasonication Time | 20 min | |
| Dispersion Quality | Good | |
| Dispersion Stability | More than two weeks | |

### Example VII

### Characterization of Carbon Nanotube-Containing Nanofluids

The two samples tested here both contain 0.05 wt % F-SWNT-CNI dispersed in PAC Solution but with different pH values. The pH value of sample A is 9.95 whereas the pH value of sample B is 10.73. Freezing points were determined according to ASTM D 1177. The current experiment was carried out as follows: the fluids were first frozen in the refrigerator, the frozen samples were then thawed at room temperature, after thawing, the samples were poured into a 250 ml beaker so that the extent of sedimentation or agglomeration could be determined qualitatively through visual inspection of the beaker. Before and after the freeze and thaw process, the two samples are stable and no precipitations were observed on either the side or bottom of the beaker. As shown in Table 7, there is no pH effect on the freezing point of the carbon nanoparticle-containing antifreeze coolant. Interestingly, however, carbon nanotube lowered freezing point of PAC Solution.

TABLE 7

| | | |
|---|---|---|
| | Freeze | |
| Refractometer | Point | Visual Stability |

| Sample | reading (° C.) | (° C.) | Before | After |
|---|---|---|---|---|
| A | −40.6 | −39.5 | Clean | Clean |
| B | −41.1 | −39.8 | Clean | Clean |

### Example VIII

### Effect of Carbon Nanotube Loading on Freezing Point

Three nanofluids in PAC Solution were prepared with different carbon nanotube loadings, including 0.05%, 0.10%, and 0.20%. Freezing points for these samples were then measured and summarized in Table 8. Clearly, the carbon nanotube loading has a significant effect on the freezing point of the nanofluid. The freezing point decreases as the loading increases. Similar effects were also observed with nanofluids of D-SWNT in EG Solution.

TABLE 8

| Nanofluid Composition | Freezing point (° C.) |
|---|---|
| PAC Solution | −35.6 |
| 0.05 wt % F-SWNT-CNI in PAC Solution | −40 |
| 0.10 wt % F-SWNT-CNI in PAC Solution | −41.1 |
| 0.20 wt % F-SWNT-CNI in PAC Solution | −42.8 |
| 0.10 wt % D-SWNT-CNI in EG Solution | −40.6 |
| 0.20 wt % D-SWNT-CNI in EG Solution | −42.2 |

### Example IX

### Determination of the Thermal Conductivities

The thermal conductivities (“TC”) of the nanofluid of the present invention were measured at room temperature using a hot disk thermal constant analyzer (Swedish Inc.). Sensor depth was set at 6 mm. Out power was set at 0.025 W. Means time was set at 16 s. Radius was set at 2.001 mm. TCR was set at 0.00471/K. Disk type of kapton was used. Tem. drift rec was on. As shown in Table 9, the thermal conductivity is increased as the carbon nanoparticle loading increases.

TABLE 9

| Nanofluid Composition | TC |
|---|---|
| 0.05% SWNT-CNI in PAC Solution with 1.00 wt % SDBS | 0.50 |
| 0.05% Acid Treated SWNT in PAC Solution with 1.00 wt % | 0.49 |
| SDBS | |
| 0.05% SWNT-HIPCO in PAC Solution with 1.00 wt % SDBS | 0.48 |
| PAC Solution with 1.00 wt % SDBS | 0.45 |

### Example X

### pH Determination

The pH values of carbon nanoparticle suspensions in a PAC Solution were measured using UP-10 pH meter (Denver Instrument at Denver, Colo.). Five different kinds of carbon nanotubes were used, including three SWNTs, that is, acid-treated, untreated, and purified F-SWNT, and two MWNTs, that is, helix and catalytic. The loading of carbon nanotubes was varied from 0.02 to 0.05% by weight. The surfactant or dispersant used in this example is sodium dodecylbenzene sulfonate (“SDBS”). As shown in Table X, all PAC solutions have relatively high pHs. For some applications, it would be beneficial to neutralize the dispersion to 7 to prevent possible corrosion. Both inorganic acids such as HCl and organic acids such as thiolgycolic acid (“TGA”) and 3-mercaptopropionic acid (“MPA”) can be used to adjust pH. However, organic acids provide an additional advantage over inorganic acids. Organic acids can also stabilize the nanoparticles dispersion.

TABLE 10

| Nanofluid Composition | pH |
|---|---|
| EG Solution | 6.55 |
| PAC Solution | 10.48 |
| PAC solution with 1.00 wt % SDBS | 9.59 |
| 0.05 wt % SWNT-CNI in PAC solution with 1.00 wt % SDBS | 10.03 |
| 0.05 wt % SWNT-CAR in PAC solution with 1.00 wt % SDBS | 10.13 |
| 0.05 wt % SWNT-MER in PAC solution with 1.00 wt % SDBS | 10.19 |
| 0.05 wt % MWNT-RAO in PAC solution with 1.00 wt % SDBS | 10.15 |
| 0.05 wt % acid treated SWNT-CNI in PAC solution with | 9.93 |
| 1.00 wt % SDBS | |
| 0.05 wt % acid treated SWNT-HIPCO in PAC solution with | 9.78 |
| 1.00 wt % SDBS | |
| 0.05 wt % F-SWNT-CNI in PAC solution with 1.00 wt % SDBS | 9.34 |
| 0.02 wt % acid treated SWNT-HIPCO in PAC solution with | 9.84 |
| 1.00 wt % SDBS | |

The examples set forth above are provided to give those of ordinary skill in the art with a complete disclosure and description of how to make and use the preferred embodiments of the compositions and the methods, and are not intended to limit the scope of what the inventors regard as their invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to he incorporated herein by reference.

What is claimed is:

1. A method for producing a hydrophilic nanofluid with enhanced thermal properties and physical characteristics comprising steps of:
preparing a mixture of a thermal transfer fluid, carbon nanoparticles, and at least one surfactant; and
applying intermittent ultrasonication to form a stable dispersion.

2. The method of claim 1, wherein the nanoparticle is selected from the group consisting of diamond nanoparticles, graphite nanoparticles, frillerenes, carbon nanotubes, and combinations thereof.

3. The method of claim 1, wherein the nanoparticle is a carbon nanotube.

4. The method of claim 3, wherein the nanotube has a diameter of from about 0.2 to about 100 nm.

5. The method of claim 3, wherein the nanotube has an aspect ratio of no greater than 1,000,000.

6. The method of claim 3, wherein the nanotube has a thermal conductivity of no less than 10 W/m·K.

7. The method of claim 1, wherein the surfactant is an anionic surfactant.

8. The method of claim 7, wherein the anionic surfactant is a sulfonate.

9. The method of claim 8, wherein the sulfonate is dodecylbenzene sulfonate.

10. The method of claim 8, wherein the sulfonate is a sulfosuccinate, a sulfosuccinamate, or a combination thereof.

11. The method of claim 10, wherein the sulfosuccinate is dioctyl sulfosuccinate, bistridecyl sulfosuccinate, or di(1,3-di-methylbutyl)sulfosuccinate.

12. The method of claim 1, wherein the thermal transfer fluid is selected from the group consisting of water, alkyl alcohols, alkylene glycols, and combinations thereof.

13. A hydrophilic nanofluid with enhanced thermal properties and physical characteristics comprising a hydrophilic thermal transfer fluid, carbon nanoparticles, and at least one surfactant.

14. The nanofluid of claim 13, wherein the hydrophilic thermal transfer fluid is selected from the group consisting of water, alkyl alcohols, alkylene glycols, and combinations thereof.

15. The nanofluid of claim 14, wherein the alkylene glycol is ethylene glycol or diethylene glycol.

16. The nanofluid of claim 13, wherein the amount by weight of the carbon nanoparticles is no greater than about 10%.

17. The nanofluid of claim 13, wherein the nanoparticle is selected from the group consisting of diamond nanoparticles, graphite nanoparticles, fullerenes, carbon nanotubes, and combinations thereof.

18. The nanofluid of claim 13, wherein the nanoparticle is a carbon nanotube.

19. The nanofluid of claim 18, wherein the nanotube has a diameter of from about 0.2 to about 100 nm.

20. The nanofluid of claim 18, wherein the nanotube has an aspect ratio of no greater than 1,000,000.

21. The nanofluid of claim 18, wherein the nanotube has a thermal conductivity of no less than 10 W/m K.

22. The nanofluid of claim 13, wherein the surfactant is an anionic surfactant.

23. The nanofluid of claim 22, wherein the anionic surfactant is a sulfonate.

24. The method of claim 23, wherein the sulfonate is dodecylbenzene sulfonate.

25. The nanofluid of claim 23, wherein the sulfonate is a sulfosuccinate, a sulfosuccinamate, or a combination thereof.

26. The nanofluid of claim 25, wherein the sulfosuccinate is dioctyl sulfosuccinate, bistridecyl sulfosuccinate, or di(1,3-di-methylbutyl)sulfosuccinate.
